(19) United States
(12) Patent Application Publication
(10) Pub. No.: US 2024/0420666 A1
(43) Pub. Date: Dec. 19, 2024

(54) TUNER

(71) Applicant: Guangzhou Rantion Technology Co., Ltd., Guangzhou (CN)

(72) Inventors: Xinhuang Peng, Guangzhou (CN); Jie Zheng, Guangzhou (CN); Shuaibo Chen, Guangzhou (CN)

(73) Assignee: Guangzhou Rantion Technology Co., Ltd., Guangzhou (CN)

(21) Appl. No.: 18/815,384

(22) Filed: Aug. 26, 2024

(30) Foreign Application Priority Data
Jul. 2, 2024 (CN) 202421537431.7

(51) Int. Cl. G10G 7/02

(52) U.S. Cl. CPC G10G 7/02

(57) ABSTRACT

A tuner comprising a body with a shell and a connecting part protruding from the bottom surface of the shell, wherein the connecting part is provided with a slotted hole with an opening deviating from the body; the tuner further includes a magnet and an elastic member accommodated in the slotted hole, wherein the magnet has an inner wall surrounding a magnetic hole, the elastic member is at least partially accommodated in the magnetic hole, and the elastic member is provided with a slot with an opening deviating from the body; the bottom surface of the magnet is flush with or higher than the bottom surface of the connecting part. Because of the magnet and the elastic member with a slot, the tuner can be fixed to the musical instrument by magnetic attraction or plugging, which can adapt to various installation methods and meet various use requirements of customers.

### CROSS-REFERENCE TO RELATED APPLICATIONS

This application claims the priority of China Patent Application No. CN 202421537431.7 filed on Jul. 2, 2024, the content of which is incorporated herein by reference.

### TECHNICAL FIELD

The present application relates to the technical field of musical instruments, in particular to a tuner.

### BACKGROUND

Tuner is an auxiliary tool for musical instruments, mainly refers to electronic tuners, which are used for tuning various stringed instruments, including guitar tuners, bass tuners, violin tuners, cello tuners, guzheng tuners and ukulele tuners. Electronic products that use vibration frequency identification programs of musical sounds to display the pitch of musical instruments have been widely used in tuning various musical instruments. According to the different applicable instruments, tuners can be divided into guitar tuners, guzheng tuners, cello tuners and violin tuners, etc. Compared with traditional tuning tools (flute, tuning fork, etc.), it has the advantages of high accuracy, easy to be influenced by climatic conditions and easy to learn, which is especially helpful for beginners of various instruments to quickly master the tuning technology of the instrument and improve their ability to listen to the pitch.

At present, there are mainly two kinds of tuner structures in the market: (1) the tuner is clamped on the guitar handle by a common clip with upper and lower clamping pieces; (2) the tuner is attraced to the iron part on the guitar by using magnets. The defects of this kind of structure are as follows: the clamping-type tuner is bulky and difficult to carry, and it can only be clamped at the head of the guitar handle; the tuner attracted by a magnet is not firmly attracted, and its application scope is limited, therefore it is not suitable for non-magnetic alloy parts, nor can it be attracted on guitar boards.

### SUMMARY

In order to overcome the problems existing in the related technology, the present application provides a tuner suitable for various installation methods.

The present application provides a tuner, which includes a body with a shell and a connecting part protruding from a bottom surface of the shell, wherein the connecting part is provided with a slotted hole with an opening deviating from the body, and the tuner further includes a magnet and an elastic member accommodated in the slotted hole; the magnet has an inner wall surrounding a magnetic hole, the elastic member is at least partially accommodated in the magnetic hole, and the elastic member is provided with a slot with an opening deviating from the body; a bottom surface of the magnet is flush with or higher than a bottom surface of the connecting part.

Preferably, the inner wall of the magnet is provided with a lead-in part.

Preferably, the elastic member is arranged above the lead-in part, a guide part is arranged at the opening of the slot, and a top end of the guide part is 2-4 mm higher than a top end of the lead-in part.

Preferably, the elastic member further includes a base connected with the slot, and the base is fixedly connected with the shell.

Preferably, the base is provided with a clamping groove, the shell is correspondingly provided with a protruding part, and the protruding part engages with the clamping groove so that the base is fixedly connected with the shell.

Preferably, the magnet has an outer wall opposite to the inner wall, the outer wall is provided with a groove, and the connecting part has a protruding part engaged with the groove.

Preferably, the tuner further includes a clip, wherein the clip is provided with an upper clamping piece and a lower clamping piece, and a surface of the upper clamping piece is provided with a spherical metal block.

Preferably, the spherical metal block is provided with a fixing groove, the upper clamping piece is provided with a fixing post, and the fixing post is inserted into the fixing groove for fixed connection.

Preferably, the tuner further includes a metal sheet, and the metal sheet is arranged separately from the tuner.

The tuner provided by the present application includes a body with a shell and a connecting part protruding from the bottom surface of the shell, wherein the connecting part is provided with a slotted hole with an opening deviating from the body; the tuner further includes a magnet and an elastic member accommodated in the slotted hole, wherein the magnet has an inner wall surrounding a magnetic hole, the elastic member is at least partially accommodated in the magnetic hole, and the elastic member is provided with a slot with an opening deviating from the body; the bottom surface of the magnet is flush with or higher than the bottom surface of the connecting part. Because of the magnet and the elastic member with a slot, the tuner can be fixed to the musical instrument by magnetic attraction or plugging, which can adapt to various installation methods and meet various use requirements of customers.

It is to be understood that both the foregoing general description and the following detailed description are exemplary and explanatory only and are not restrictive of the present application.

### BRIEF DESCRIPTION OF DRAWINGS

The above and other objects, features and advantages of the present application will become more apparent by describing the exemplary embodiments of the present application in more detail with reference to the accompanying drawings, wherein like reference signs generally represent like parts in the exemplary embodiments of the present application.

FIG. 1 is a schematic structural diagram of a tuner shown in an embodiment of the present application;

FIG. 2 is a schematic sectional view of the tuner shown in the embodiment of the present application;

FIG. 3 is a schematic structural diagram of the magnet of the tuner shown in the embodiment of the present application;

FIG. 4 is a schematic sectional view of the magnet of the tuner shown in the embodiment of the present application;

FIG. 5 is a structural schematic diagram of an elastic member of the tuner shown in the embodiment of the present application;

FIG. 6 is a schematic sectional view of the elastic member of the tuner shown in the embodiment of the present application;

FIG. 7 is a schematic structural diagram of the clip of the tuner shown in the embodiment of the present application;

FIG. 8 is a schematic sectional view of the clip of the tuner shown in the embodiment of the present application;

FIG. 9 is a structural schematic diagram of a spherical metal block on the clip of the tuner shown in the embodiment of the present application;

FIG. 10 is a schematic sectional view of a spherical metal block on the clip of the tuner shown in the embodiment of the present application;

FIG. 11 is a schematic structural diagram of the metal sheet of the tuner shown in the embodiment of the present application;

FIG. 12 is a schematic sectional view of the connecting state of the tuner and the clip shown in the embodiment of the present application;

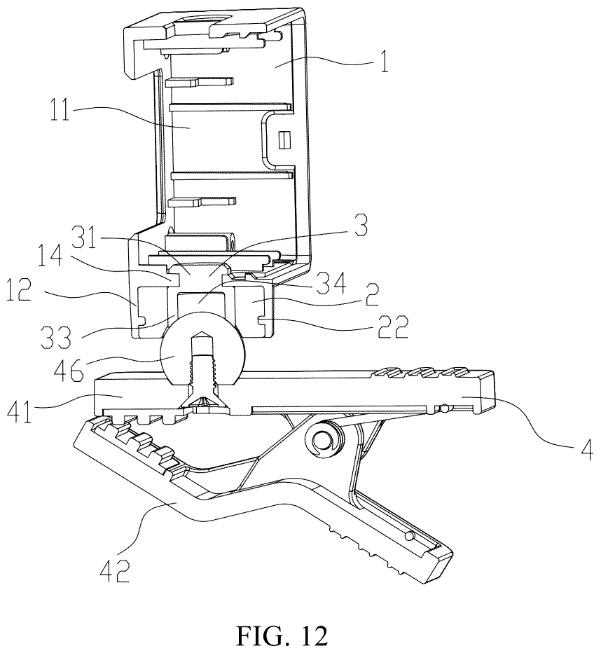

FIG. 13 is one of the present application scenarios of the tuner shown in the embodiment of the present application;

FIG. 14 is the second schematic diagram of the present application scene of the tuner shown in the embodiment of the present application;

FIG. 15 is the third schematic diagram of the present application scenario of the tuner shown in the embodiment of the present application;

FIG. 16 is the fourth schematic diagram of the present application scene of the tuner shown in the embodiment of the present application;

FIG. 17 is the fifth schematic diagram of the present application scenario of the tuner shown in the embodiment of this application.

### REFERENCE SIGNS

Body 1; Shell 11; Connecting part 12; Slotted hole 13; Protruding part 14;
Magnet 2; Groove 21; Magnetic hole 22; Lead-in part 23;
Elastic member 3; Base 31; Clamping groove 32; Extending part 33; Slot 34; Guide part 35;
Clip 4; Upper clamping piece 41; Lower clamping piece 42; Rotating shaft 43; Torsion spring 44; Fixing post 45; Spherical metal block 46; Fixing groove 47;
Metal sheet 5;
Scroll 6;
Fret 7;
Body 8.

### DESCRIPTION OF EMBODIMENTS

Preferred embodiments of the present application will be described in more detail below with reference to the accompanying drawings. Although preferred embodiments of the present application are shown in the drawings, it should be understood that the present application can be implemented in various forms and should not be limited by the embodiments set forth herein. Rather, these embodiments are provided so that this application will be thorough and complete, and will fully convey the scope of this application to those skilled in the art.

The terminology used in this application is for the purpose of describing specific embodiments only and is not intended to limit this application. The singular forms “a”, “said” and “the” used in this application and the appended claims are also intended to include the plural forms, unless the context clearly indicates other meaning. It should also be understood that the term “and/or” as used herein refers to and includes any or all possible combinations of one or more associated listed items.

It should be understood that although the terms “first”, “second” and “third” may be used in this application to describe various information, these information should not be limited to these terms. These terms are only used to distinguish the same type of information from each other. For example, without departing from the scope of this application, the first information can also be called the second information, and similarly, the second information can also be called the first information. Therefore, the features defined as “first” and “second” may include one or more of these features explicitly or implicitly. In the description of this application, “plural” means two or more, unless otherwise specifically defined.

Hereinafter, the technical solution of the embodiment of the present application will be described in detail with the attached drawings.

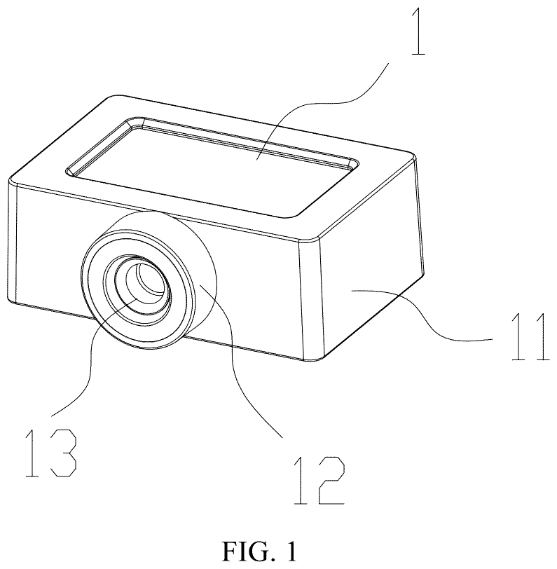

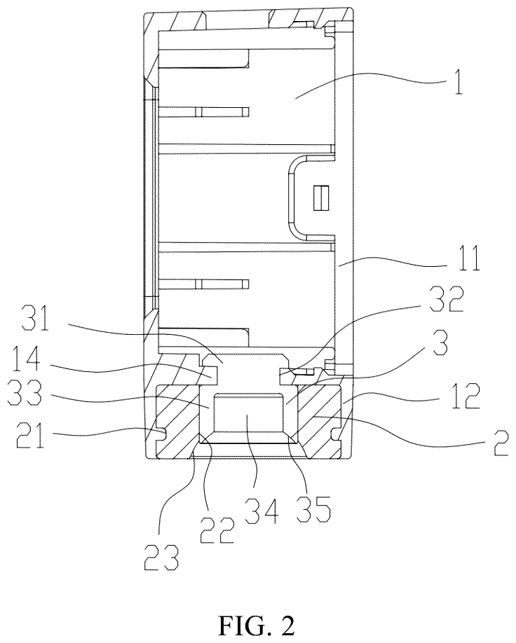

FIG. 1 is a schematic structural diagram of a tuner shown in an embodiment of the present application; FIG. 2 is a schematic sectional view of the tuner shown in the embodiment of the present application.

Referring to FIGS. 1 and 2, the present application provides a tuner, which is fixed on a musical instrument when in use and used for detecting the sound and tone of the musical instrument. It includes a body 1, which can be directly connected and positioned on the musical instrument through magnetic adsorption, or it includes a body 1 and a fixing device, which can be detachably positioned on the musical instrument, and the body 1 is connected with the fixing device by magnetic adsorption. In this embodiment, the fixing device is a clip 4. In this tuner, the body 1 is connected with the clip 4 through the adsorption of the magnet 2, and the body 1 can be fixed on the musical instrument in cooperation with the clip 4, and can also be adsorbed on the musical instrument by the magnet 2 alone. When the space on the musical instrument is not enough, so that the fixing force obtained by clamping the clip 4 on the musical instrument is not enough, the body 1 can be used alone, and the use will not be affected by the unstable clamping of the clip 4, which brings great convenience to the user. In addition, the body 1 can also be inserted on the strings of musical instruments. This tuner can bring different usage modes and usage scenarios to customers, meet various usage needs of customers, and bring better usage experience.

Referring to FIGS. 1 and 2, the tuner includes a body 1 with a shell 11 and a connecting part 12 protruding from the bottom surface of the shell 11. The connecting part 12 is provided with a slotted hole 13 with an opening deviating away from the body 1. The tuner further includes a magnet 2 and an elastic member 3 accommodated in the slotted hole 13, wherein the magnet 2 has an inner wall surrounding the magnetic hole 22, and the elastic member 3 is at least partially accommodated in the magnetic hole 22, and the elastic member 3 is provided with a slot 34 with an opening deviating away from the body 1. The magnet 2 in the slot 13 can be multiple or single. The magnets 2 can be magnetic rings or magnets 2 with other shapes can be spliced together.

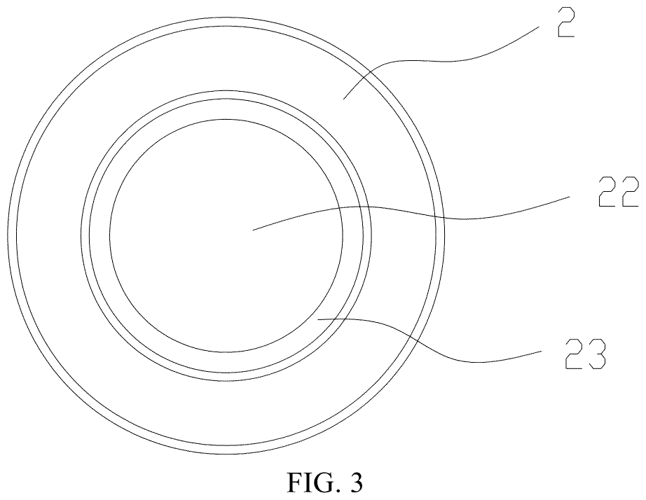

In this embodiment, as shown in FIGS. 1 to 4, the magnet 2 is a magnetic ring, which includes an inner wall surrounding a magnetic hole 22 and an outer wall opposite to the inner wall. The magnetic hole 22 passes through the magnet 2, and a groove 21 is formed on the outer wall. The groove 21 is an annular groove 21 formed on the surface of the magnetic ring, and the connecting part 12 has a protruding part 14 engaged with the groove 21 to fix the magnet 2.

In this embodiment, referring to FIG. 2, the shell 11 and the magnet 2 are integrally injection molded. During the injection molding process, the plastic injection will fill the groove 21 on the magnet 2, so that the magnet 2 is fixedly connected with the shell 11 and is not easy to separate or loosen. Specifically, in order to fix the magnet 2 in the tuner so as not to be pulled out, an annular groove 21 is opened, which can be filled when the shell 11 is injected, so that the magnet 2 and the shell 11 are integrated. In this tuner, the shell 11 and the magnet 2 are integrally injection molded, and the groove 21 is filled with plastic, so that the magnet 2 and the shell 11 are fixedly connected, and the shell 11 and the magnet 2 are integrated, so that the magnet 2 will not loosen and the normal use of the tuner will not be affected.

Referring to FIG. 2, in other alternative embodiments, the connecting part 12 is hollow and cylindrical, and the magnet 2 is embedded in the cylindrical inner wall, so that the magnet 2 will not fall out during use.

In addition, the bottom surface of the magnet 2 is flush with or higher than the bottom surface of the connecting part 12. Referring to FIG. 2, in this embodiment, the bottom surface of the magnet 2 is flush with the bottom surface of the connecting part 12, that is to say, the magnet 2 is partially exposed outside the shell 11, and the exposed plane of the magnet 2 is flush with the cylindrical top surface, so that the magnet 2 can directly contact the metal when it is adsorbed on the metal piece, by which the magnetic force of the magnet 2 will not be weakened, and it can be adsorbed on the iron piece or other planar metal pieces very stably. In other embodiments, the bottom surface of the magnet 2 can be (slightly) higher than the bottom surface of the connecting part 12, so that the magnet 2 can directly contact with the metal when it is better adsorbed on the metal piece, so that the magnetic force of the magnet 2 will not be weakened, and it can be adsorbed on the iron piece or other planar metal piece very stably.

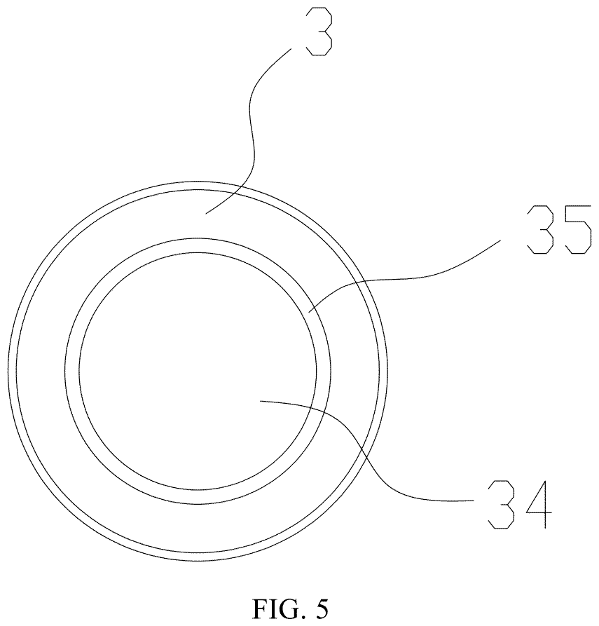

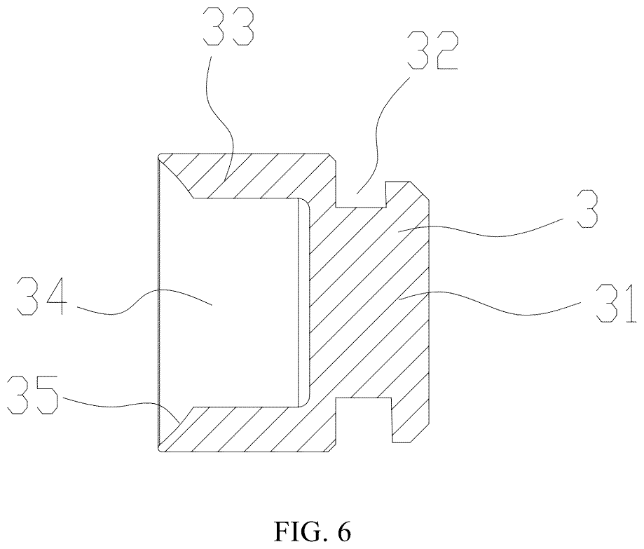

The magnet 2 surrounds to form a magnetic hole 22, an elastic member 3 is arranged in the magnetic hole 22, and the shape of the elastic member 3 is shown in FIG. 5. In order to facilitate the insertion of the tuner into the fret 7, one side of the elastic member 3 is designed as a cylinder, and the inner hole has a diameter of Ø5.4˜5.7 mm and a depth of 3.8-4.2 mm, which can be well inserted into the fret and fixed. Referring to FIG. 6, the elastic member 3 is provided with a base 31, and the base 31 is connected with an extending part 33. Referring to FIG. 2, the base 31 is fixedly connected with the shell 11 through the magnetic hole 22, and the extending part 33 is arranged in the magnetic hole 22, and the extending part 33 is internally provided with a slot 34 from the bottom surface, which is used for connecting with the outside. Referring to FIGS. 2 and 6, the base 31 is provided with a clamping groove 32, and the shell 11 is correspondingly provided with a protruding part 14. The protruding part 14 engages with the clamping groove 32 to fixedly connect the base 31 with the shell 11, so that the elastic member 3 can be stuck on the shell 11 of the tuner without being pulled out.

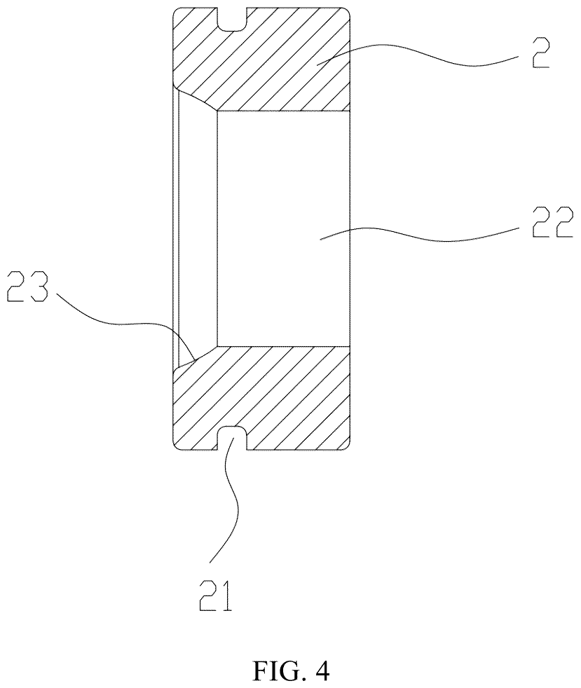

Specifically, referring to FIG. 4, the opening of the magnetic hole 22, that is, the inner wall of the magnet 2, is provided with a lead-in part 23, so that the opening of the magnetic hole 22 extends inward in a trumpet shape, which is convenient for introducing the connector (fret) to be connected into the slot 34. Further, the elastic member 3 is arranged above the lead-in part 23, and a guide part 35 is arranged at the opening of the slot 34, and the top end of the guide part 35 is 2-4 mm higher than the top end of the lead-in part 23, so that the connector (fret) can be easily led into the slot 34. In some alternative embodiments, referring to FIG. 2, the top surface of the extending part 33 is lower than the top surface of the magnet 2, so that the extending part 33 is completely embedded in the magnetic hole 22.

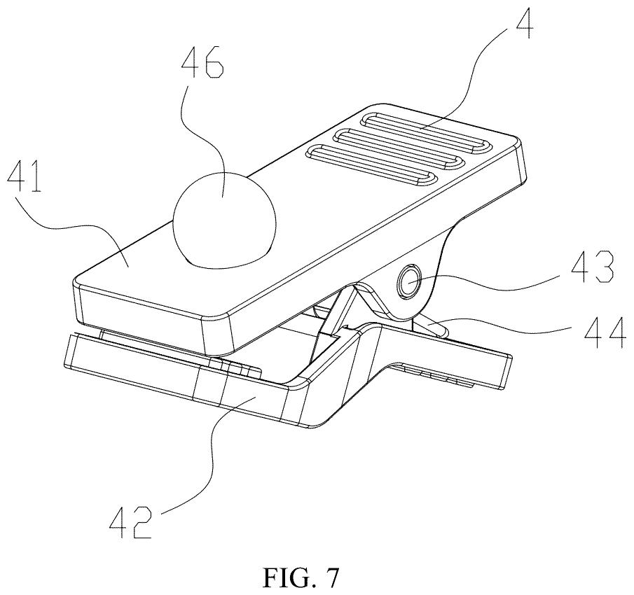

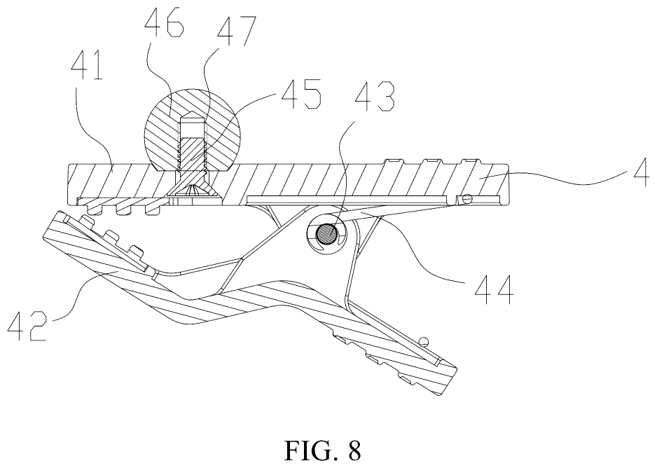

Referring to FIGS. 7 and 8, the tuner is also connected with a clip 4, which is provided with an upper clamping piece 41 and a lower clamping piece 42. In this embodiment, a rotating shaft 43 and a torsion spring 44 are arranged between the upper clamping piece 41 and the lower clamping piece 42, and the rotating shaft 43 and the torsion spring 44 movably connect the upper clamping piece 41 and the lower clamping piece 42 together. The surface of the upper clamping piece 41 is provided with a spherical metal block 46 which is movably connected with the connecting part 12. The spherical metal block 46 is partially accommodated in the magnetic hole 22, and its surface is tangent to the lead-in part 23. In this embodiment, the spherical metal block 46 is a steel ball, and when the steel ball is attracted to the magnet 2, the guide part 35 of the elastic member 3 is approximately tangent to the steel ball.

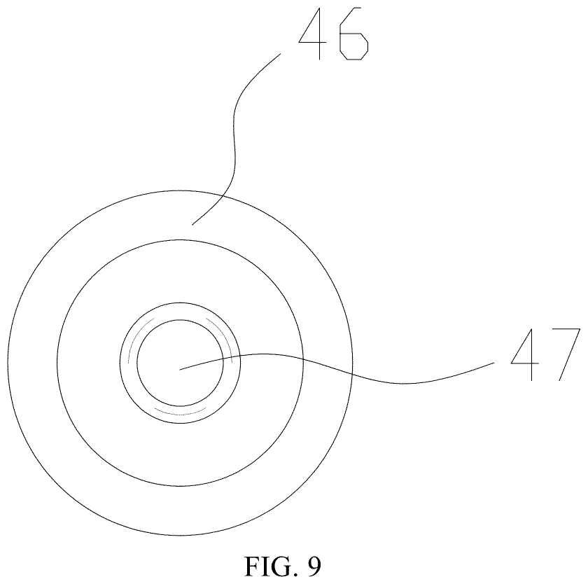

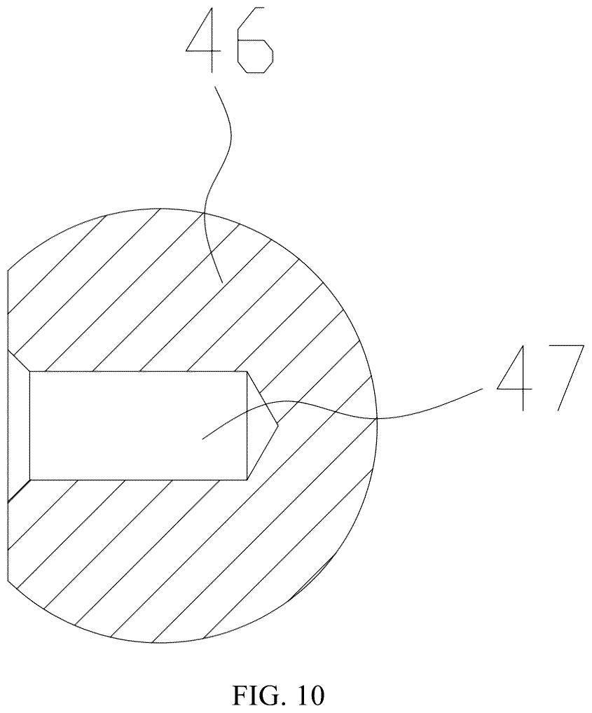

Further, referring to FIGS. 8, 9 and 10, the spherical metal block 46 is provided with a fixing groove 47, and the upper clamping piece 41 is provided with a fixing post 45, and the fixing post 45 is inserted into the fixing groove 47 for fixed connection. In this embodiment, the fixing groove 47 is a threaded hole, and the fixing post 45 is a screw, and the screw is fixedly connected with the threaded hole, so that the spherical metal block 46 is fixedly connected to the upper clamping piece 41. By using the connection mode of screws and threaded holes, it is more convenient to assemble, disassemble and replace, and different spherical metal blocks 46 can be replaced according to different requirements, not only the size and shape of the spherical metal blocks 46, so that the present application scope of the clip 4 is wider. In addition, the clip 4 is provided with a spherical metal block 46, which is movably connected with the connecting part 12 of the shell 11. During use, the clip 4 and the shell 11 are stably connected and will not fall off due to vibration or other external forces, so that the detection of the tuner during use is more accurate.

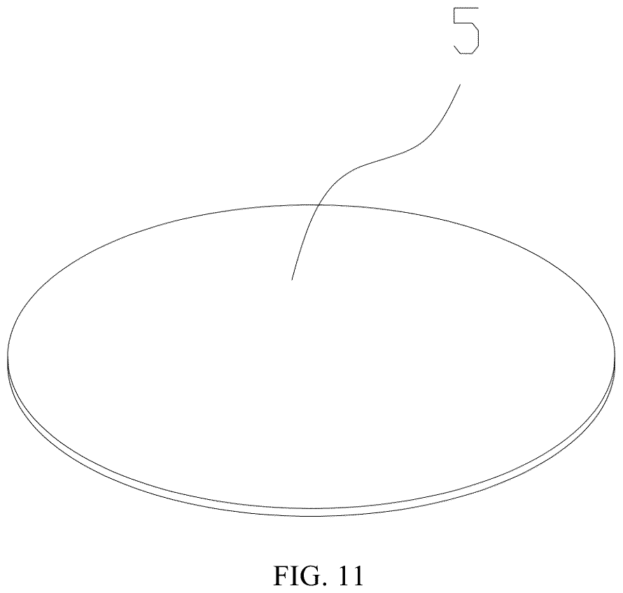

FIG. 11 is a schematic structural diagram of the metal sheet of the tuner shown in the embodiment of the present application.

Referring to FIG. 11, the tuner further includes a metal plate 5, which is arranged separately from the tuner. In this embodiment, the metal sheet 5 is a circular iron sheet, which is matched with the connecting part 12 on the body 1, and at the same time, it is more convenient for the magnet 2 in the body 1 to absorb the metal sheet 5.

This tuner can realize the use of various scenes and provide users with more and more convenient experience.

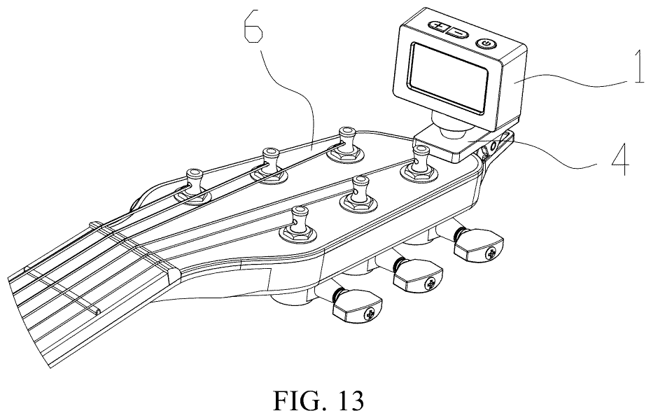

FIG. 13 is one of the present application scenarios of the tuner shown in the embodiment of the present application.

Referring to FIG. 13, the combination with the matching clip 4 is conventionally used. The clip 4 is clamped on the scroll 6, and the tuner is adsorbed on the steel ball on the clip 4, and the tuner can be rotated to adjust the angle. Specifically, when the tuner and the clip 4 are clamped together on the scroll 6 for use, the tuner is attracted to the steel ball through the magnet 2, and at the same time, the elastic member 3 can generate a certain friction force, so that the whole tuner can be stably attracted to the clip 4, and at the same time, the tuner can rotate on the steel ball through external force to overcome the friction force of the elastic member 3, thus achieving the function of adjusting the tuner angle.

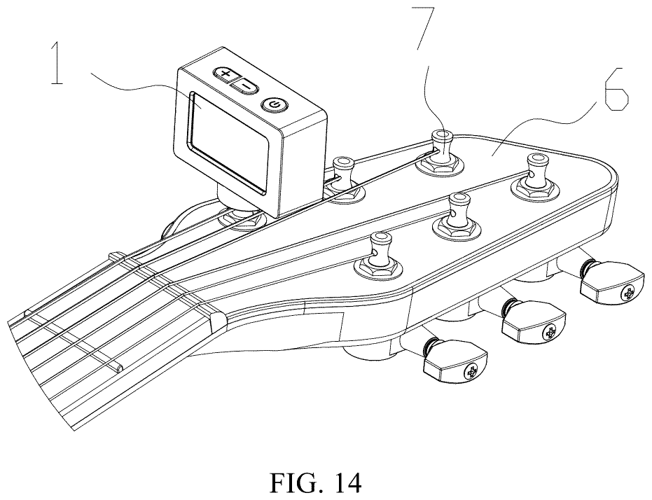

FIG. 14 is the second schematic diagram of the present application scenario of the tuner shown in the embodiment of the present application.

Referring to FIG. 14, the tuner is directly inserted into the fret 7 on the scroll 6 for use. When it is used as shown in FIG. 14, the inner hole of the elastic member 3 on the tuner can be aligned with the string post 7 on the scroll 6 for insertion without the clip 4, so that the tuner can be directly inserted on the string post 7 for use. The inner diameter of the elastic member 3 is Ø5.6 mm, which is smaller than the outer diameter of the fret 7 (usually about Ø6.0 mm), so that the tuner can be clamped on the fret 7 and meanwhile the angle of the tuner can be adjusted by hand.

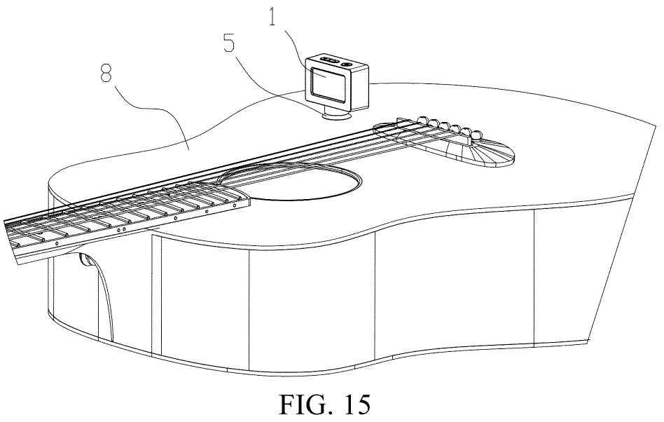

FIG. 15 is the third schematic diagram of the present application scenario of the tuner shown in the embodiment of the present application.

See FIG. 15. At the same time, a circular iron sheet is provided, which can be adhered to any plane on the body 8, and the plane area needs to meet the size of about Ø20 mm, and then the tuner can be adsorbed on the iron sheet for use. When it is used as shown in FIG. 15, first a plane with a diameter larger than that of the iron sheet is found on the body 8, and then the iron sheet is stuck on the body 8 with double-sided tape, and then the tuner is adsorbed on the iron sheet for use, or the angle may be adjusted.

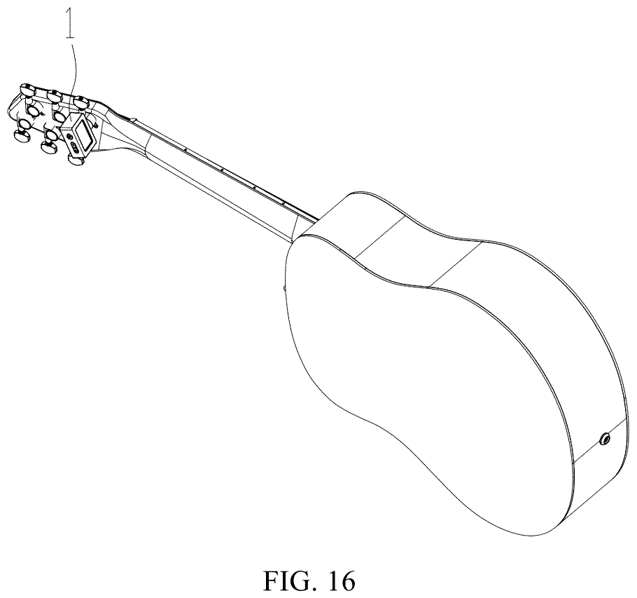

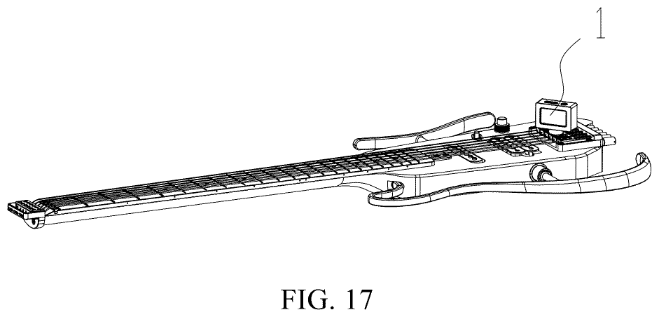

FIG. 16 is the fourth schematic diagram of the present application scene of the tuner shown in the embodiment of the present application; FIG. 17 is the fifth schematic diagram of the present application scenario of the tuner shown in the embodiment of this application.

In addition, as shown in FIG. 16 and FIG. 17, there are some flat and large-area metals on guitars, basses and other musical instruments, and the tuners can be directly adsorbed on them without using iron sheets.

Embodiments of the present application have been described above, and the above description is exemplary, not exhaustive, and is not limited to the disclosed embodiments. Many modifications and changes will be obvious to those skilled in the art without departing from the scope and spirit of the illustrated embodiments. The terminology used herein is chosen to best explain the principles of various embodiments, practical application or improvement of technology in the market, or to enable other people skilled in the art to understand various embodiments disclosed herein.

What is claimed is:

1. A tuner, comprising a body with a shell and a connecting part protruding from a bottom surface of the shell, wherein the connecting part is provided with a slotted hole with an opening deviating from the body, and the tuner further includes a magnet and an elastic member accommodated in the slotted hole; the magnet has an inner wall surrounding a magnetic hole, the elastic member is at least partially accommodated in the magnetic hole, and the elastic member is provided with a slot with an opening deviating from the body; a bottom surface of the magnet is flush with or higher than a bottom surface of the connecting part.

2. The tuner according to claim 1, wherein the inner wall of the magnet is provided with a lead-in part.

3. The tuner according to claim 2, wherein the elastic member is arranged above the lead-in part, a guide part is arranged at the opening of the slot, and a top end of the guide part is 2-4 mm higher than a top end of the lead-in part.

4. The tuner according to claim 3, wherein the elastic member further includes a base connected with the slot, and the base is fixedly connected with the shell.

5. The tuner according to claim 4, wherein the base is provided with a clamping groove, the shell is correspondingly provided with a protruding part, and the protruding part engages with the clamping groove so that the base is fixedly connected with the shell.

6. The tuner according to claim 1, wherein the magnet has an outer wall opposite to the inner wall, the outer wall is provided with a groove, and the connecting part has a protruding part engaged with the groove.

7. The tuner according to claim 1, further comprising a clip, wherein the clip is provided with an upper clamping piece and a lower clamping piece, and a surface of the upper clamping piece is provided with a spherical metal block.

8. The tuner according to claim 7, wherein the spherical metal block is provided with a fixing groove, the upper clamping piece is provided with a fixing post, and the fixing post is inserted into the fixing groove for fixed connection.

9. The tuner according to claim 1, wherein the tuner further includes a metal sheet, and the metal sheet is arranged separately from the tuner.
